(19) United States
(12) Patent Application Publication
(10) Pub. No.: US 2006/0229974 A1
(43) Pub. Date: Oct. 12, 2006

(54) Method of extending credit to at least one consumer and method of processing a transaction between a consumer and a merchant

(75) Inventors: Thomas H. Keithley, Monkton, MD (US); Vincent W. Talbert, Cockeysville, MD (US); Mark L. Lavelle, Govans, MD (US)

Correspondence Address: THE WEBB LAW FIRM, P.C., 700 KOPPERS BUILDING, 436 SEVENTH AVENUE, PITTSBURGH, PA, 15219, US

(73) Assignee: I4 Licensing LLC, Timonium, MD (US)

(21) Appl. No.: 11/102,940

(22) Filed: Apr. 11, 2005

(51) Int. Cl. G06Q 40/00

(52) U.S. Cl. 705/38

(57) ABSTRACT

Disclosed is a method of extending credit to a consumer, including the steps of: offering, to the consumer, a credit account having a private label portion associated with a specified private label entity and a credit issuer network portion for use with a merchant in a credit issuer network; activating at least one portion of the credit account; engaging in a transaction by the consumer, where the consumer uses at least one portion of the credit account; and processing the transaction by a credit issuer processing system. A method of processing a transaction between the consumer having a private label credit account affiliated with a specified private label entity and a merchant and apparatus is also disclosed.

### BACKGROUND OF THE INVENTION

1. Field of the Invention

The present invention relates generally to the provision of credit or a loan to a consumer for engaging in a credit-based transaction and, in particular, to a method of extending credit to a consumer and a method of processing a transaction between a consumer having a private label credit account affiliated with a specified private label entity and a merchant.

2. Description of Related Art

In order to enable convenient purchases of goods and services by consumers, the financial service industry has developed many alternative payment methods that allow a consumer to engage in a transaction and receive goods and services on credit. For example, such alternative payment methods may include checks, ATM or debit cards, credit cards, charge cards, etc. In addition, these credit vehicles are able to be used on many platforms and via many communication methods and processes. For example, a credit or charge card may be used over the telephone, by mail order, electronically over the Internet or at an in-store location. The benefit of existing payment methods allow a consumer to move the point-of-sale (POS) from an in-store location to one's home. For example, a consumer may place an order from a catalog over the telephone and use a credit card or charge card to pay for the goods and/or services. A similar process can be used for mail orders.

Virtual commerce and the growth of the Internet as a medium for commerce have placed pressure on the payment options discussed above with respect to both convenience, transaction security and the profitability by the credit issuer. However, the consumer's convenience is paramount, and the Internet provides yet another POS, or option, to the consumer for purchasing goods and/or services via an alternative medium.

In order to maintain and increase customer loyalty, there are many private label entities that issue private label credit cards or credit accounts to consumers for use at the private label entity or some affiliated merchant. Therefore, the private label account of the consumer is segregated from any of the consumer's general usage credit vehicles. For example, the typical general usage credit accounts and cards, such as VISA, Mastercard, etc. are capable of being used at any number of merchants in the credit issuer's network. This network allows the consumer the ability to use the general usage credit card at a vast number of merchants, with the only limitation being that the merchant be in the credit issuer's network. In one instance, the private label entity or merchant may be in this network.

Presently, even if the private label merchant or entity is in the general credit issuer's network, there exists a wall between the private label credit card processing system 300 and a general usage credit card processing system 302. See FIG. 1. Such a separation is easily seen, since both the private label entity and the general usage credit issuer use a different underwriting system, authorization system, billing system, servicing system, etc.

One example, of such transactions and the drawbacks of the prior art are illustrated in FIG. 2. In this example, in one transaction, a consumer 304 conducts this private label transaction with a merchant 306 using his or her private label credit account, such as a private label credit card. The merchant 306 must then interact with or otherwise communicate with the private label credit card processing system 300 in order to obtain authorization for the transaction, and subsequently settle the transaction. In another example, the consumer 304 uses his or her general usage credit account or credit card with the same merchant 306. However, since the consumer 304 is conducting a general usage transaction with the merchant 306, the merchant 306 interacts with or otherwise communicates with the general usage credit card processing system 302, as opposed to the private label credit card processing system 300. In particular, the merchant 306, in this example, must obtain authorization from and settle with the general usage credit card processing system 302, as opposed to the private label credit card processing system 300. This illustrates the above-discussed barrier or wall between the private label credit card processing system 300 and the general usage credit card processing system 302.

It is disadvantageous for the private label entity to set up, maintain and operate its own private label credit card processing system 300 for underwriting, authorizing, billing, servicing, etc. It is particularly disadvantageous, since the general usage credit issuer already maintains the system 302 and related services for such transactions. This required duplication of systems and services by the private label entity represents an area where the private label entity can obtain a vast cost savings, and also where the general usage credit issuer can obtain additional income.

Another drawback to these prior art systems is that the consumer 304 is limited to the use of his or her private label credit card or credit account at only a single or affiliated private label entity, which often represents a very limited number of merchants and, therefore, POS options. In order to engage in transactions with other merchants, the consumer must obtain some other general usage credit card in order to successfully accomplish this. This represents an inconvenience to the consumer, as well as a lost opportunity for profit to the credit issuer.

### SUMMARY OF THE INVENTION

It is, therefore, an object of the present invention to provide a method of extending credit to at least one consumer and a method of processing a transaction between a consumer and a merchant that overcome the deficiencies of the prior art. It is another object of the present invention to provide a method of extending credit to at least one consumer that provides a credit account with a private label portion associated with a specified private label entity and a credit issuer network portion associated with at least one merchant in a credit issuer network. It is a further object of the present invention to provide a method of extending credit to at least one consumer that relieves the need for duplicate systems between a private label entity and a general credit issuer. It is a still further object of the present invention to provide a method of processing a transaction between a consumer having a private label credit account affiliated with a specified private label entity and a merchant that allows for transaction processing by a general credit issuer processing system, regardless of the merchant's affiliation with the private label entity. It is yet another object of the present invention to provide a method of extending credit to a consumer and a method of processing a transaction between the consumer and a merchant that allows a greater number of transactions using a single credit account.

The present invention is directed to a method of extending credit to at least one consumer. This method includes the steps of: (a) offering, to the consumer, a credit account having: (i) a private label portion associated with a specified private label entity; and (ii) a credit issuer network portion associated with at least one merchant in a credit issuer network; (b) activating at least one of the private label portion and the credit issuer network portion of the credit account; (c) engaging in a transaction by the consumer with at least one of the specified private label entity and a merchant in the credit issuer network, wherein the consumer utilizes at least one of the private label portion and the credit issuer network portion of the credit account; and (d) processing the transaction by a credit issuer processing system. In one preferred and non-limiting embodiment, the method further includes the steps of: initially activating the private label portion of the credit account; receiving authorization from the consumer to activate the credit issuer network portion of the credit account; and subsequently activating the credit issuer network portion of the credit account.

The present invention is also directed to a method of processing a transaction between a consumer having a private label credit account affiliated with a specified private label entity and a merchant. The method includes the steps of: engaging in a transaction by the consumer with the merchant, wherein the consumer uses the private label credit account as a payment method in the transaction; communicating transaction data by the merchant to a general credit issuer processing system; and processing a transaction by the general credit issuer processing system. In one preferred and non-limiting embodiment, the specified private label entity is a merchant, a group, an organization, a corporate entity, a company, a credit issuer, an affiliation, etc. In another preferred and non-limiting embodiment, the general credit issuer processing system is operated by a general credit issuer, an online credit issuer, etc.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a schematic view of a private label credit card processing system in a general usage credit card processing system according to the prior art;

FIG. 2 is a schematic view of a transaction between a consumer, a merchant and a processing system according to the prior art;

FIG. 3 is a block diagram of a method of extending credit to at least one consumer according to the present invention;

FIG. 4 is a block diagram of a method of processing a transaction between a consumer having a private label credit account affiliated with a specified private label entity and a merchant according to the present invention; and

FIG. 5 is a schematic view of one embodiment of a system for extending credit and processing a transaction between a consumer and a merchant according to the present invention.

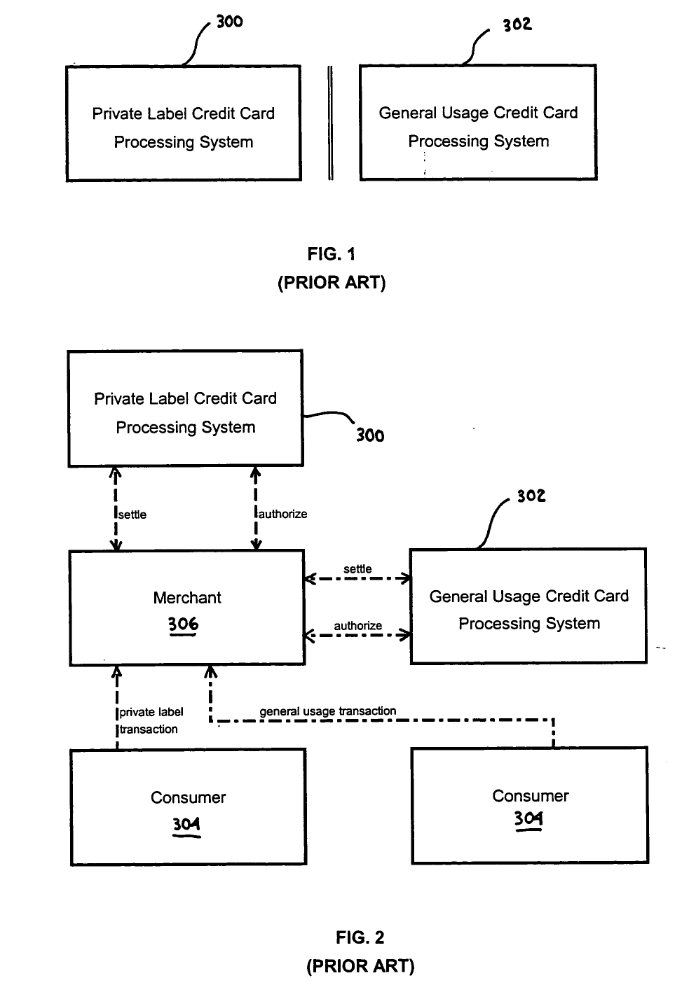

### DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

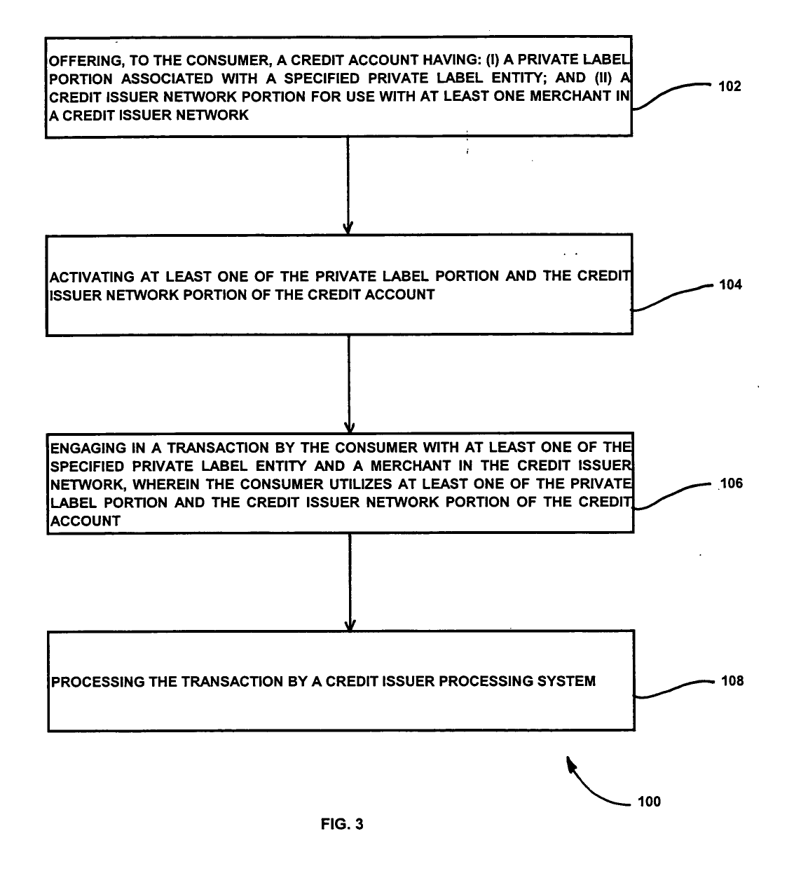

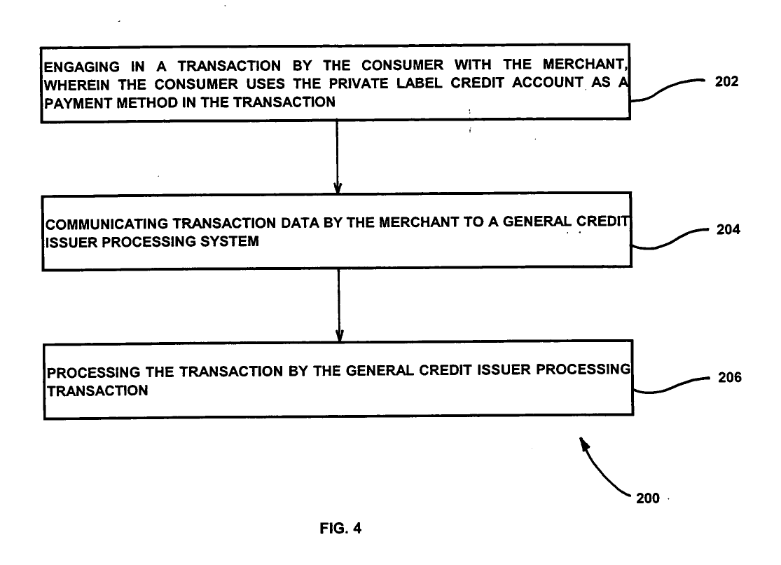

The present invention is directed to a method, system and apparatus for extending credit to at least one consumer, as well as to a method of processing a transaction between a consumer having a private label credit account affiliated with a specified private label entity and a merchant. The method of extending credit to at least one consumer according to the present invention is illustrated in FIG. 3, and a method of processing a transaction between a consumer and a merchant is illustrated in FIG. 4. The present invention is also directed to an apparatus and system for extending credit to at least one consumer, and an apparatus and system for processing a transaction between a consumer and a merchant. It is envisioned that such apparatus implements one or more portions of the preferred embodiments of the method and system of the present invention in a computer-implemented format. For example, one or more of the steps of the methods of the present invention, as discussed in more detail hereinafter, may be automatically performed by a computing device, such as a personal computer, a network device, a laptop, a palmtop, a personal digital assistant, a server, a printed circuit board, etc. Therefore, various portions of the presently-invented methods and systems may be enhanced by, augmented by or otherwise conducted over a computer or network system.

In one preferred and non-limiting embodiment, as illustrated in FIG. 3, the present invention is directed to a method 100 of extending credit to at least one consumer. This method 100 includes the steps of: (a) offering, to the consumer, a credit account having: (i) a private label portion associated with a specified private label entity; and (ii) a credit issuer network portion for use with at least one merchant in a credit issuer network (Step 102); activating at least one of the private label portion and the credit issuer network portion of the credit account (Step 104); engaging in a transaction by the consumer with at least one of the specified private label entity and a merchant in the credit issuer network, wherein the consumer utilizes at least one of the private label portion and the credit issuer network portion of the credit account (Step 106); and processing a transaction by a credit issuer processing system (Step 108).

In another preferred and non-limiting embodiment, the present invention is also directed to a method 200 of processing a transaction between a consumer having a private label credit account affiliated with a specified private label entity and a merchant. This method is illustrated in FIG. 4. In particular, the method 200 includes the steps of: engaging in a transaction by the consumer with the merchant, wherein the consumer uses the private label credit account as a payment method in the transaction (Step 202); communicating transaction data by the merchant to a general credit issuer processing system (Step 204); and processing the transaction by the general credit issuer processing system (Step 206).

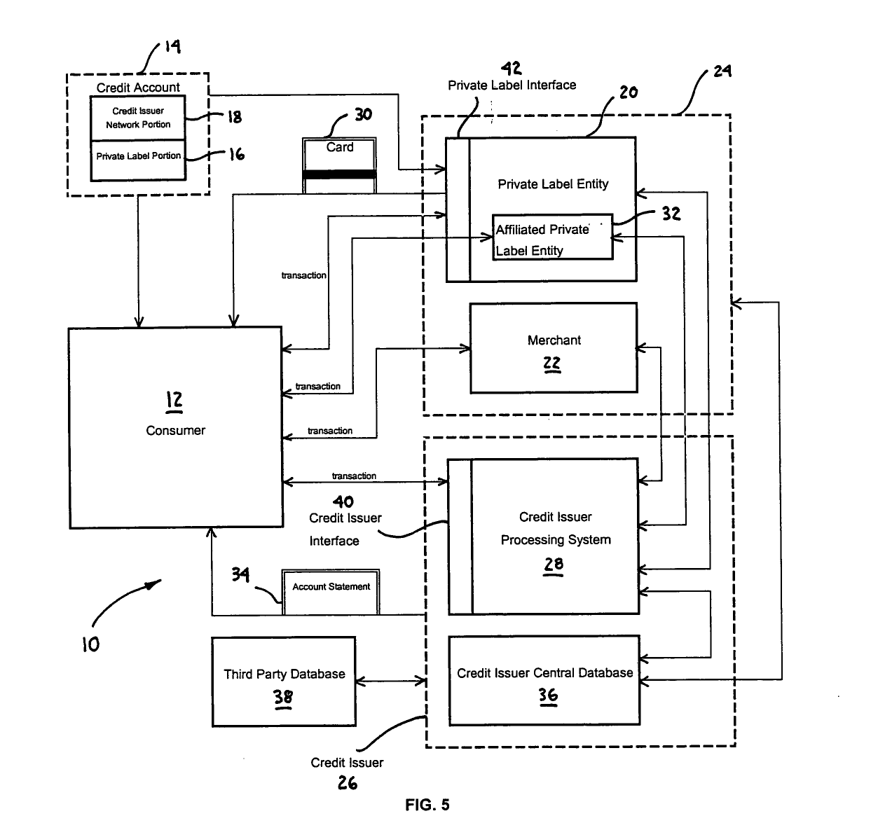

Both the method 100 of extending credit to at least one consumer, as well as the method 200 of processing a transaction between a consumer and a merchant are schematically illustrated in one preferred and non-limiting embodiment, in FIG. 5. In particular, a system 10 is illustrated that implements these methods 100, 200, preferably in a computerized or network environment. However, it should be understood that neither of the methods 100, 200 accordingly to the present invention require a computerized environment in order to be effectively implemented.

In one embodiment, the system 10 allows for the extension of credit to one or more consumers 12. In particular, a credit account 14 is offered to a consumer 12. This credit account 14 includes a private label portion 16 and a credit issuer network portion 18. Specifically, the private label portion 16 is associated with or otherwise affiliated with a specified private label entity 20, and the credit issuer network portion 18 is associated for use with at least one merchant 22 in a credit issuer network 24. Next, the private label portion 16 and/or the credit issuer network portion 18 of the credit account 14 are activated typically by a credit issuer 26 that has provided a group of merchants 22 in the credit issuer network 24.

Next, the consumer 12 engages in a transaction with either the private label entity 20, some affiliated private label entity 32 or a merchant 22 in a credit issuer network 24. Further, the consumer 12 uses either the private label portion 16 and/or the credit issuer network portion 18 of the credit account 14 in this transaction. It is envisioned that the private label entity 20, affiliated private label entity 32 or merchant 22 in this transaction are all part of the credit issuer network 24. Finally, the transaction is processed by a credit issuer processing system 28.

The method 100, as implemented in the system 10, illustrates that, even if the consumer 12 engages in a transaction with the private label entity 20 (or some affiliated private label entity 32 or merchant 22) using the private label portion 16 of the credit account 14, this transaction is still processed in the credit issuer processing system 28. This means that there is no need for the private label entity 20 to manage and maintain its own processing system to process such transactions. Accordingly, the methods 100, 200 and system 10 alleviate the need for duplicate effort.

The initial activation of the credit account 14 may be only partial in nature. In particular, it is envisioned that only the private label portion 16 and/or only the credit issuer network portion 18 are activated. For example, in one embodiment, the private label portion 16 of the credit account 14 is initially activated. Next, the consumer 12 provides some sort of authorization to activate the more general credit issuer network portion 18 of the credit account 14. The credit issuer 26 will then subsequently activate the credit issuer network portion 18 of the credit account 14, such that the consumer 12 can now engage in transactions with any of the merchants 22 in the credit issuer network 24.

The initial offer to the consumer 12 may occur in a variety of communication types. For example, this offer may occur over the telephone, by facsimile, by mail, by e-mail, over the Internet, etc. In addition, the acceptance of this offer by the consumer 12 may also occur over the above-discussed mediums.

After acceptance and activation of the credit account 14, the private label entity 20 and/or the credit issuer 26 may provide a card 30 to the consumer 12. This card 30 can be used in subsequent transactions by the consumer 12 and, as is known in the art, this card 30 may be in the form of a credit card that can be swiped or otherwise used at any point-of-sale. In one preferred embodiment, the card 30 is in the form of a private label credit card that can be utilized within the credit issuer network 24, after activation of the credit issuer network portion 18 of the credit account 14. Accordingly, the consumer 12 now has a card 30 that can be used not only at the private label entity 20 (and affiliated entities 32 and merchants 22), but also, in a more general sense, in connection with any merchant 22 in the credit issuer network 24. The specified private label entity 20 may be a merchant 22, a group, an organization, a corporate entity, a company, a credit issuer 26, an affiliation, etc.

In use, the consumer 12 engages in a transaction with the specified private label entity 20, an affiliated private label entity 32 or some affiliated merchant 22. In this transaction, the consumer 12 utilizes the private label portion 16 of the credit account 14. However, this transaction is still processed in the credit issuer processing system 28. Similarly, the consumer 12 may engage with a merchant 22 in the credit issuer network 24 utilizing the credit issuer network portion 18 of the credit account 14. Again, this transaction is processed by the credit issuer processing system 28.

Another benefit to using a single credit issuer processing system 28 in both transactions (both private label entity 20 transactions and credit issuer network 24 transactions), is that the credit issuer 26 may provide an account statement 34 to the consumer 12. The account statement 34 may be in paper form and/or electronic form. Of particular benefit, is the fact that, since the credit issuer 26 is using the credit issuer processing system 28, the credit issuer 26 may provide a combined account statement 34 to the consumer 12. In particular, the account statement 34 may be a combined statement of transactions between the consumer 12 and the specified private label entity 20, the affiliated private label entity 32, a merchant 22 and a credit issuer network 24, etc. In summary, all transactions may be combined in a single account statement 34 provided to the consumer 12.

In a further embodiment of the present invention, the specified private label entity 20, the affiliated private label entity 32, a merchant 22 and/or the credit issuer 26 may make some sort of subsequent offer to the consumer 12. For example, the consumer 12 may be offered a service, an item, a discount, a redemption, a coupon, a voucher, a non-cash benefit, an incentive, a ticket, an invitation, an event, etc. In one embodiment, the consumer 12 is provided with points that can accrue and be used to purchase or otherwise redeem any of these types of items and services. Further, the offer to the consumer 12 may be based upon the activation of the private label portion 16 of the credit account 14; activation of the credit issuer network portion 18 of the credit account 14; use of the private label portion 16 and/or the credit issuer network portion 18 of the credit account 14; some data associated with the use of the credit account 14; and/or transaction data relating to one or more of the consumer 12 transactions using the credit account 14. In general, the consumer 12 may be awarded by the private label entity 20 and/or the credit issuer 26 based upon his or her use of the credit account 14 on a transactional basis.

In a further embodiment, the consumer's 12 use of the credit account 14 is tracked, which allows the private label entity 20 and/or the credit issuer 26 to compile tracking data specific to the consumer 12. As discussed above, the consumer 12 may be offered various services, items, discounts, redemptions, coupons, etc. based upon this tracking data or some value reflective of the consumer's 12 use of the private label portion 16 and/or the credit issuer network portion 18 of the credit account 14.

It is envisioned that the consumer 12 may accept the offer, whether the initial offer of the credit account 14 or any subsequent offer by the private label entity 20 and/or the credit issuer 26, in various forms. For example, the consumer may accept offers in written form, verbal form, transmission of an application, or some other indication of acceptance. It is also envisioned that the private label entity 20, and in one preferred embodiment, the credit issuer 26, assesses the consumer 12. For example, the consumer 12 may be assessed: prior to offering the credit account 14 to the consumer 12; prior to accepting, by the consumer 12, the offer; prior to activating the private label portion 16 and/or the credit issuer network portion 18 of the credit account 14; during a transaction by the consumer 12; after a transaction by the consumer 12; during a subsequent transaction by the consumer 12; and/or after a subsequent transaction by the consumer 12. In one embodiment, the assessment of the consumer 12 includes: transmitting data to a credit issuer central database 36; transmitting data to a third-party database 38; processing data related to the consumer 12; rating the consumer 12; and/or verifying the authenticity of the consumer 12. For example, the consumer 12 may be rated for credit risk, fraud risk, profitability, risk factors, etc.

The system 10 allows the credit issuer 26 and/or the private label entity 20 to perform assessments based upon a variety of data collected regarding a consumer 12. In one embodiment, the central credit issuer database 36 and/or the third-party database 38 include data sets. These data sets include a variety of fields populated with data. For example, this data may reflect a consumer's 12 name, an account number, an address, a city, a state, a zip code, a country, a telephone number, an e-mail address, a social security number, a date of birth, a merchant's 22 name, an identification, an order number, an authorization number, an authorization time, an authorization amount, a ship-to address, a bill-to address, a transaction amount, a consumer 12 purchase demographic, a transaction date, a transaction type, a product identification, a service identification, shipping costs, delivery time, customer type, a company identity, a merchant 22 identity, a third-party risk score, a general credit risk score, a credit bureau risk score, a prior approval, a prior report data, previous transaction data, a geographical risk factor, credit account 14 data, bank card balance data, delinquency data, credit segment data, time between transactions data, previous transaction amount, previous transaction approval status, previous transaction time stamp data, a response code, active trades in database, public record data, trade line data, transaction medium, credit segment data, consumer 12 payment type, consumer 12 payment method, consumer 12 payment history, consumer 12 account history, consumer 12 credit account 14 balance, merchant 22 history, private label entity 20 data, affiliated private label entity 32 data, etc. Using any one or more of these fields of data, the credit issuer 26 and/or the private label entity 20 may approve the consumer 12 before, during or after opening the credit account 14, or before, during or after each transaction.

In one embodiment, the initial offer and/or the activation of the credit account 14 may be engaged in by the specified private label entity 20, the credit issuer 26, a general credit issuer, a merchant 22, an online credit issuer, a credit issuer interface 40, a private label entity interface 42, an affiliated private label entity 32, etc. In the case of the credit issuer interface 40 and the private label entity interface 42, these subsystems act as front ends to the private label entity 20 and the credit issuer 26 respectively. It is with these interfaces 40, 42 that the consumer 12 interacts, communicates with and otherwise engages with. For example, the interface 40, 42 may include a telephone subsystem, an online web site, etc.

As discussed above, the present invention is also directed to the method 200 of processing a transaction between the consumer 12 and a merchant 22. In particular, the consumer 12, at this point, already has an active credit account 14, which may be an exclusive credit account 14 for use only at the private label entity 20 or affiliated private label entity 32. When the consumer 12 engages in a transaction with the merchant 22, the consumer 12 uses the private label credit account 14 as a payment method in the transaction. Transaction data is communicated by the merchant 22 to the credit issuer processing system 28, which, in this embodiment, is a general credit issuer processing system 28. Next, the transaction is processed by the general credit issuer processing system 28. Again, this demonstrates the use of the credit issuer processing system 28 for use in processing transactions when the consumer 12 uses a private label credit account 14.

In the above embodiment, the merchant 22 may be the private label entity 20, the affiliated private label entity 32, and/or a merchant 22 in the credit issuer network 24. Further, the specified private label entity 20 may be a merchant 22, a group, an organization, a corporate entity, a company, a credit issuer, an affiliation, etc. The general credit issuer processing system 28 may be operated by the credit issuer 26, a general credit issuer, an online credit issuer, etc.

As discussed above, the present invention is also directed to apparatus to perform the methods 100, 200 and implement the system 10. In one preferred and non-limiting embodiment, any one or more of the steps of the methods 100, 200 are implemented in a network computer environment, such as online or on the Internet. In this example, all of the communications between the consumer 12, the private label entity 20 and the credit issuer 26 are in electronic form. However, any number of the additional steps or subsystems can be implemented in a non-computerized environment.

In this manner, the present invention provides a method of extending credit to a consumer 12, as well as a method of processing a transaction between the consumer 12 and a merchant 22. The present invention further provides methods 100, 200 that establish accounts and allow transactions, where the accounts and transactions are processed in a credit issuer processing system 28. Further, the present invention allows for a private label entity 20 to maintain and offer a private label card 30, without the need for maintaining its own processing system. Therefore, the private label entity 20 may delegate the bulk of the tasks to the credit issuer 26, such as underwriting, authorization, billing, servicing, etc. In addition, the present invention allows the consumer 12 to have access to a vast number of merchants 22 in a general credit issuer network 24, as opposed to limited use of the private label card 30 only with the private label entity 20 or some affiliated private label entity 32. Accordingly, the methods 100, 200 and system 10 of the present invention save costs for the private label entity 20, as well as a merchant 22. However, the private label entity 20 still retains the brand recognition that it desires by offering such a private label credit account 14.

This invention has been described with reference to the preferred embodiments. Obvious modifications and alterations will occur to others upon reading and understanding the preceding detailed description. It is intended that the invention be construed as including all such modifications and alterations.

The invention claimed is:

1. A method of extending credit to at least one consumer comprising the steps of:
(a) offering, to the consumer, a credit account having: (i) a private label portion for use with a specified private label entity; and (ii) a credit issuer network portion for use with at least one merchant in a credit issuer network;
(b) activating at least one of the private label portion and the credit issuer network portion of the credit account;
(c) engaging in a transaction by the consumer with at least one of the specified private label entity and a merchant in the credit issuer network, wherein the consumer utilizes at least one of the private label portion and the credit issuer network portion of the credit account; and
(d) processing the transaction by a credit issuer processing system.

2. The method of claim 1, further comprising the steps of:
initially activating the private label portion of the credit account;
receiving authorization from the consumer to activate the credit issuer network portion of the credit account; and
subsequently activating the credit issuer network portion of the credit account.

3. The method of claim 1, wherein the offer to the consumer occurs via at least one of telephone, facsimile, mail, e-mail and Internet.

4. The method of claim 1, further comprising the step of providing, by at least one of the specified private label entity and a credit issuer, to the consumer, a card for use in subsequent transactions.

5. The method of claim 4, wherein the card is in the form of a private label credit card that can be utilized within the credit issuer network.

6. The method of claim 1, wherein the specified private label entity is at least one of a merchant, a group, an organization, a corporate entity, a company, a credit issuer and an affiliation.

7. The method of claim 1, further comprising the steps of:
engaging in a transaction by the consumer with at least one of the specified private label entity and an affiliated private label merchant, wherein the consumer utilizes the private label portion of the credit account; and
processing the transaction by the credit issuer processing system.

8. The method of claim 1, further comprising the steps of:
engaging in a transaction by the consumer with a merchant in the credit issuer network utilizing the credit issuer network portion of the credit account;
processing the transaction by the credit issuer processing system.

9. The method of claim 1, further comprising the step of providing, by a credit issuer to the consumer, an account statement in at least one of paper and electronic form.

10. The method of claim 9, wherein the account statement is a combined statement of transactions between the consumer and at least one of the specified private label entity, an affiliated private label merchant and a merchant in the credit issuer network.

11. The method of claim 1, further comprising the step of offering, by at least one of the specified private label entity, a merchant in the credit issuer network and a credit issuer, to the consumer, at least one of a service, an item, a discount, a redemption, a coupon, a voucher, a non-cash benefit, an incentive, a ticket, an invitation and an event, based upon at least one of (i) activation of the private label portion of the credit account; (ii) activation of the credit issuer network portion of the credit account; (iii) use of the private label portion of the credit account; (iv) use of the credit issuer network portion of the credit account; (v) data associated with the use of the credit account; and (vi) transaction data.

12. The method of claim 1, further comprising the step of tracking the consumer's use of the credit account, thereby compiling tracking data specific to a consumer.

13. The method of claim 12, further comprising the step of offering, by at least one of the specified private label entity, a merchant in the credit issuer network and a credit issuer, to the consumer, at least one of a service, an item, a discount, a redemption, a coupon, a voucher, a non-cash benefit, an incentive, a ticket, an invitation and an event, based upon at least one of (i) the tracking data for the consumer; (ii) a value reflective of the consumer's use of the private label portion of the credit account; (iii) a value reflective of the consumer's use of the credit issuer network portion of the credit account; (iv) data associated with the use of the credit account; and (v) transaction data.

14. The method of claim 1, wherein the consumer accepts the offer in at least one of written form, verbal form, transmission of an application and an indication of acceptance.

15. The method of claim 1, further comprising the step of assessing the consumer at least one of:
(i) prior to offering the credit account to the consumer;
(ii) prior to accepting, by the consumer, the offer;
(iii) prior to activating at least one of the private label portion and the credit issuer network portion of the credit account for the consumer;
(iv) during the transaction by the consumer;
(v) after the transaction by the consumer;
(vi) during a subsequent transaction by the consumer; and
(vii) after a subsequent transaction by the consumer.

16. The method of claim 15, wherein the assessing step further includes at least one of:
(i) transmitting data to a credit issuer central database;
(ii) transmitting data to a third-party database;
(iii) processing data relating to the consumer;
(iv) rating the consumer; and
(v) verifying the authenticity of the consumer.

17. The method of claim 16, wherein the consumer is rated for at least one of credit risk, fraud risk, profitability and risk factors.

18. The method of claim 16, wherein at least one of the central credit issuer database and the third-party database includes a data set including at least one field populated with data reflecting a consumer's name, an account number, an address, a city, a state, a zip code, a country, a telephone number, an e-mail address, a social security number, a date of birth, the merchant's name, an identification, an order number, an authorization number, an authorization time, an authorization amount, a ship-to address, a bill-to address, a transaction amount, a consumer purchase demographic, a transaction date, a transaction type, a product identification, a service identification, shipping costs, delivery type, customer type, a company identity, a merchant identity, a third-party risk score, a general credit risk score, a credit bureau risk score, a prior approval, prior report data, previous transaction data, a geographical risk factor, credit account data, bankcard balance data, delinquency data, credit segment data, time between transactions data, previous transaction amount, previous transaction approval status, previous transaction time stamp data, a response code, active trades in database, public record data, trade line data, transaction medium, credit segment data, consumer payment type, consumer payment method, consumer payment history, consumer account history, consumer credit account balance, merchant history, private label entity data and affiliated private label entity.

19. The method of claim 15, further comprising the step of approving the consumer based upon the assessment.

20. The method of claim 1, wherein at least one of steps (a)-(d) is automatically performed by a computing device.

21. The method of claim 18, wherein the computing device is at least one of a personal computer, a networked device, a laptop, a palmtop, a personal digital assistant and a server.

22. The method of claim 1, wherein the credit issuer is at least one of the specified private label entity, a general credit issuer and an online credit issuer.

23. The method of claim 1, wherein at least one of the offering step (a) and the activating step (b) are engaged in by at least one of the specified private label entity, a credit issuer, a general credit issuer, a merchant, an online credit issuer, a credit issuer interface, a private label entity interface and an affiliated private label merchant.

24. A method of processing a transaction between a consumer having a private label credit account affiliated with a specified private label entity and a merchant, the method comprising the steps of:
engaging in a transaction by the consumer with the merchant, wherein the consumer uses the private label credit account as a payment method in the transaction;
communicating transaction data by the merchant to a general credit issuer processing system; and
processing the transaction by the general credit issuer processing system.

25. The method of claim 24, wherein the merchant is at least one of the private label entity, an affiliated private label merchant and a merchant in a credit issuer network.

26. The method of claim 24, wherein the specified private label entity is at least one of a merchant, a group, an organization, a corporate entity, a company, a credit issuer and an affiliation.

27. The method of claim 24, wherein the general credit issuer processing system is operated by at least one of a general credit issuer and an online credit issuer.

28. An apparatus for extending credit to at least one consumer comprising the steps of:
means for offering, to the consumer, a credit account having: (i) a private label portion associated with a specified private label entity; and (ii) a credit issuer network portion for use with at least one merchant in a credit issuer network;
means for activating at least one of the private label portion and the credit issuer network portion of the credit account;
means for engaging in a transaction by the consumer with at least one of the specified private label entity and a merchant in the credit issuer network, wherein the consumer utilizes at least one of the private label portion and the credit issuer network portion of the credit account; and
means for processing the transaction by a credit issuer processing system.
